(19) United States
(12) Patent Application Publication
(10) Pub. No.: US 2025/0089905 A1
(43) Pub. Date: Mar. 20, 2025

(54) MATTRESS

(71) Applicant: KABUSHIKI KAISYA LEBEN, Yokohama-shi (JP)

(72) Inventor: Atsushi TAKABU, Kanagawa (JP)

(21) Appl. No.: 18/963,725

(22) Filed: Nov. 28, 2024

Related U.S. Application Data
(63) Continuation of application No. PCT/JP2024/005025, filed on Feb. 14, 2024.

(30) Foreign Application Priority Data
Feb. 15, 2023 (JP) 2023-021361
Feb. 27, 2023 (JP) 2023-028454
Nov. 7, 2023 (JP) 2023-190172

(51) Int. Cl. A47C 21/04; A47C 27/00; A47C 27/15; B32B 3/30; B32B 5/02; B32B 5/18; B32B 5/24; B32B 5/26; B32B 5/32; B32B 37/24; B32B 38/00

(52) U.S. Cl. CPC A47C 21/044; A47C 27/006; B32B 3/30; B32B 5/02; B32B 5/18; B32B 5/245; B32B 5/26; B32B 5/32; B32B 37/24; B32B 38/0004; A47C 27/15; B32B 2037/243; B32B 2307/51; B32B 2307/7242; B32B 2479/00

(57) ABSTRACT

To provide a mattress which can be used comfortably with good quality by distributing airflow inside. A mattress comprises a breathable elastic layer, a non-breathable covering layer covering the elastic layer, a ventilation portion that is not covered by the covering layer, and a ventilation mechanism. The covering layer is a coating film that is integrated with the elastic layer and covers the surface thereof. In the mattress air supplied to the elastic layer is discharged from the ventilation portion or air supplied to the ventilation portion is discharged from the elastic layer by the ventilation mechanism.

### TECHNICAL FIELD

The present invention relates to mattresses. The present invention claims priority to Japanese Patent Application No. 2023-190172 filed on Nov. 7, 2023, the contents of which are incorporated by reference herein in its entirety in designated states where the incorporation of documents by reference is approved.

### BACKGROUND ART

Mattresses that comfortably support users' bodies have been developed.

For example, PTL 1 describes an air conditioned bed capable of sending air to the surface of a mattress (FIG. 1, etc.).

### CITATION LIST

### Patent Literature

PTL 1: JP2014-23967A

### SUMMARY OF INVENTION

### Technical Problem

In the mattress described above, it is necessary to combine non-breathable members to form a flow path to efficiently send air to the surface of the mattress. However, since breathability cannot be ensured in areas other than the flow path, ventilation inside the mattress may not be sufficient, and comfortable sleep or use may not be obtained.

Therefore, an object of the present invention is to provide a mattress which can be used comfortably with good quality by distributing airflow inside.

### Solution to Problem

The present application includes a plurality of means for solving at least a part of the problems described above, and examples thereof are as follows. A mattress according to an aspect of the present invention that solves the above-mentioned problems comprises a breathable elastic layer, a non-breathable covering layer covering the elastic layer, a ventilation portion that is not covered by the covering layer, and a ventilation mechanism. The covering layer is a coating film that is integrated with the elastic layer and covers the surface thereof. In the mattress air supplied to the elastic layer is discharged from the ventilation portion or air supplied to the ventilation portion is discharged from the elastic layer by the ventilation mechanism.

The ventilation mechanism may suck the supplied air from a position different from the position where the air is supplied.

The covering layer may be formed by heat-treating the surface of the elastic layer into the coating film.

Another aspect of the present invention relates to a method of manufacturing a mattress. The mattress comprises a breathable elastic layer, a non-breathable covering layer covering the elastic layer, a ventilation portion that is not covered by the covering layer, and a ventilation mechanism. In the mattress air supplied to the elastic layer is discharged from the ventilation portion or air supplied to the ventilation portion is discharged from the elastic layer by the ventilation mechanism. The method comprises (1) heat treating the surface of the elastic layer into a coating film, (2) heat treating a covering material covering the surface of the elastic layer into a coating film, or (3) applying a liquid covering material to the surface of the elastic layer and solidifying it to form a coating film, thereby forming the covering layer that is integrated with the elastic layer and covers the surface thereof.

The method may comprise forming the ventilation portion by cutting or removing the covering layer.

The elastic layer may comprise a main elastic layer and a sub-elastic layer having higher breathability than the main elastic layer and to which the ventilation mechanism is connected. The method may comprise laminating the main elastic layer and the sub-elastic layer and cutting the main elastic layer by profile processing.

### Advantageous Effects of Invention

According to the present invention, it is possible to provide the mattress which can be used comfortably with good quality by distributing airflow inside.

Problems, configurations, and effects other than those described above will be clarified by the following description of embodiments.

### BRIEF DESCRIPTION OF DRAWINGS

FIG. 1 is a schematic diagram showing an example of a mattress according to Embodiment 1.

FIG. 2 is a schematic diagram showing an example of a manufacturing process of the mattress according to Embodiment 1.

FIG. 3 is a schematic diagram showing an example of a manufacturing process of the mattress according to Embodiment 1.

FIG. 4 is a schematic diagram showing an example of a mattress according to Modification 1 of Embodiment 1.

FIG. 5 is a schematic diagram showing an example of a mattress according to Modification 2 of Embodiment 1.

FIG. 6 is a schematic diagram showing an example of a mattress according to Embodiment 2.

FIG. 7 is a diagram for explaining airflow of the mattress according to Embodiment 2.

FIG. 8 is a schematic diagram showing an example of a mattress 2a according to Modification 1 of Embodiment 2.

FIG. 9 is a schematic diagram showing an example of a mattress 2b according to Modification 2 of Embodiment 2.

FIG. 10 shows an example of a mattress 2c according to Modification 3 of Embodiment 2.

FIG. 11 is a schematic diagram showing an example of a mattress 2d according to Modification 4 of Embodiment 2.

### DESCRIPTION OF EMBODIMENTS

Hereinafter, examples of embodiments of the present invention will be described with reference to the drawings. Note that constituent elements common to the following embodiments are denoted by the same reference signs as those that have been already described, and description thereof may be omitted. In addition, in the case of referring to the shape, positional relationship, and the like of the constituent elements and the like, those substantially approximate or similar to the shape and the like are included unless explicitly described otherwise or unless the shape is considered to be obviously not included in principle.

The present invention relates to mattresses which are used by being laid on beds, sofas, chairs or the like to support users' bodies. In other words, a mattress according to the present invention is referred to as a so-called mattress laid on a bed, a so-called cushion laid on a sofa, a so-called Japanese zabuton laid on a chair or tatami mat, or the like depending on the object to be laid. A mattress according to the present invention can also be used as a pillow.

A mattress according to one aspect of the present invention comprises a main elastic layer, a covering layer, at least one ventilation portion, and a ventilation mechanism for ventilating the inside of the mattress. The covering layer is a non-breathable coating film covering the main elastic layer. The mattress allows air to pass through the main elastic layer by providing the ventilation portion that is not covered by the covering layer.

### Embodiment 1

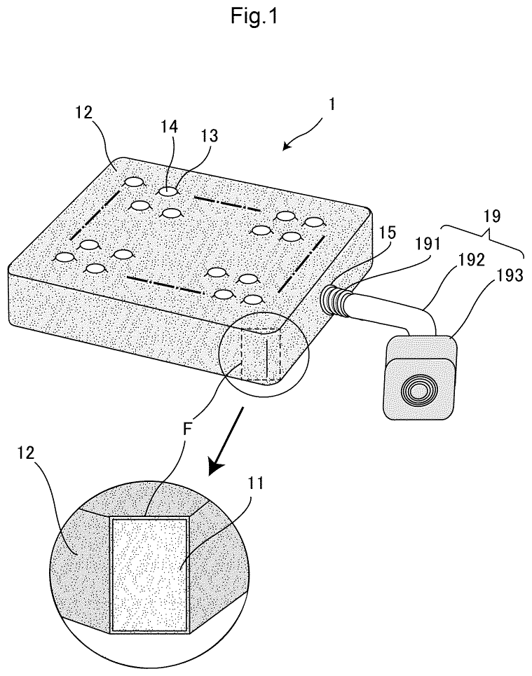

FIG. 1 is a schematic diagram showing an example of a mattress 1 according to Embodiment 1. In the mattress 1 of the present embodiment, air is sent to a breathable main elastic layer 11 covered with a non-breathable covering layer 12 by a ventilation mechanism 19 to generate airflow to a plurality of ventilation portions 14 provided on the upper surface (hereinafter, referred to as a pressing surface) to be pressed by the body of a user in use. Hereinafter, it will be specifically described. The broken line F in FIG. 1 is a cross-sectional line provided for convenience to show the inside of the mattress 1.

The main elastic layer 11 is a layer forming the inside of the mattress 1, and is composed of an elastic body having breathability, appropriate thickness, and appropriate elasticity. The thickness of the main elastic layer 11 is not particularly limited, and can be configured to be a thickness required for a mattress. For the main elastic layer 11, as an example, an elastic body utilizing synthetic resin or the like having breathability and thermoplastic or thermosetting property is used, for example, a foam material such as a polyethylene foam, a rubber sponge, or a urethane foam, or a cushioning material such as a resin fiber cushioning material.

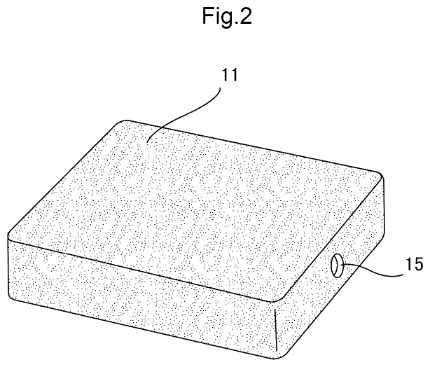

The covering layer 12 is a surface layer of the main elastic layer 11, and covers the entire main elastic layer 11 except for the ventilation portions 14 and an air supply and exhaust port 15. The covering layer 12 is formed by subjecting the surface of the main elastic layer 11 as shown in FIG. 2 to a heat treatment, so that the surface of the main elastic layer 11 itself is melted and integrated into a film as a non-breathable coating film. Therefore, when pressed, the covering layer 12 deforms following the deformation of the main elastic layer 11, so that there is no gap between the main elastic layer 11 and the covering layer 12. In this example, the air supply and exhaust port 15 is formed in advance, but may be formed later. The thickness of the covering layer 12 may be any degree in consideration of sleeping comfort and the like as long as there is no leakage of gas, for example, 0.5 to 5.0 mm, preferably 0.5 to 3 mm, and more preferably 0.5 to 2.0 mm.

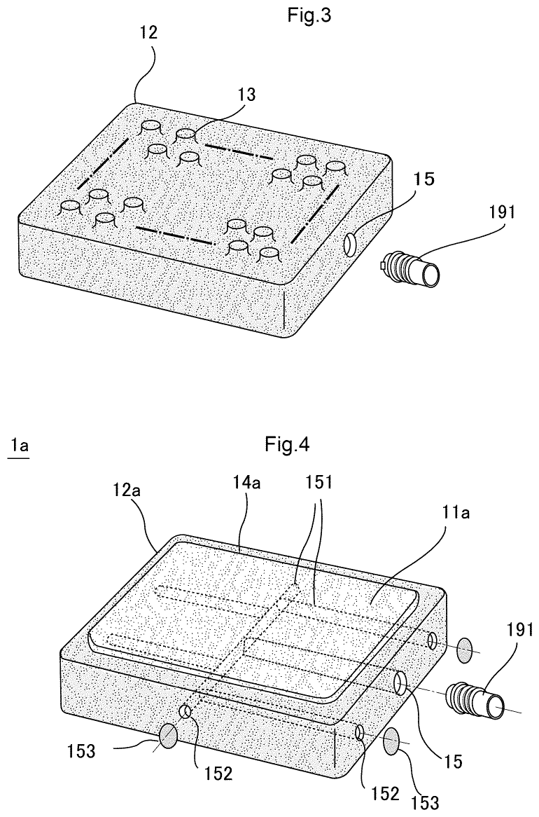

The heat treatment of the surface of the main elastic layer 11 can be performed, for example, by fitting the main elastic layer 11 into a mold and treating it at a high temperature to form the covering layer 12. At that time, by providing holes at predetermined locations on the upper side of the mold, the expanding main elastic layer 11 expands along the holes in the mold to form protrusions 13 as shown in FIG. 3. The protrusions 13 can be formed larger by compressing the main elastic layer 11 using the mold during heat treatment and pushing the protrusions 13 out through the holes. Thereafter, by cutting the upper portion of each protrusion 13, the main elastic layer 11 inside is exposed from the cut edges, and the ventilation portions 14 having breathability are formed. The ventilation portions 14 receive air supply and exhaust from the ventilation mechanism 19 connected to the air supply and exhaust port 15, and allow ventilation to the pressing surface through the inside of the mattress 1.

The ventilation mechanism 19 includes a connection member 191 connected to the air supply and exhaust port 15, a hose 192 connecting the connection member 191 and a ventilator 193, and the ventilator 193 for generating airflow. The ventilator 193 is a device for generating supply airflow, exhaust airflow, or both to the mattress 1. When air supply is performed, the air sent from the ventilator 193 is distributed to the main elastic layer 11 inside the mattress 1 and is discharged from ventilation portions 14 formed on the pressing surface. On the other hand, when air exhaust is performed, air is taken in through the ventilation portions 14, and this airflow passes through the main elastic layer 11, flows into the ventilation mechanism 19 through the air supply and exhaust port 15, and is discharged to the outside. Any mechanism may be used for such a ventilator 193, and examples thereof include a propeller fan, a blower, a cross-flow fan, or the like. The ventilator 193 may have a temperature and humidity adjusting function. The ventilator 193 can be driven by a switch, a controller, a remote controller, or the like. The ventilator 193 may be attached by directly connecting the ventilator 193 to the air supply and exhaust port 15. The connection member 191, for example, may be inserted in advance into the air supply and exhaust port 15, and then fixed thereto by forming the covering layer 12.

As described above, according to the present embodiment, the main elastic layer 11 is coated by the non-breathable covering layer 12 that is integrated with the surface of the main elastic layer 11, so that the airflow can be distributed to every corner inside the main elastic layer 11. Furthermore, since the main elastic layer 11 and the covering layer 12 are integrated, no gap is generated between them, and no air current is accumulated therein. This allows mattresses, which are generally difficult to air out easily, to be ventilated efficiently and thoroughly inside, maintaining good sanitary conditions.

Furthermore, since the covering layer 12 prevents air from leaking in or out from any portion other than the ventilation portions 14, it is possible to efficiently send air only to the ventilation portions 14. In this example, the ventilation portions 14 are provided only on the pressing surface that the user comes into contact with, making it possible to comfortably adjust the humidity and temperature around the human body. For example, when the user feels hot, cool air can be ventilated, and when the user feels cold, warm air can be ventilated, resulting in a more comfortable sleep.

Furthermore, in terms of the manufacturing method, the main elastic layer 11 is heat-treated to form a film that functions as the covering layer 12, so there is no need to prepare a separate covering material, windbreak cover, or the like, or to form a flow path. In addition, the ventilation portions 14 can be produced very simply by removing the covering layer 12 at predetermined positions and forming the exposed portions of the main elastic layer 11 on the surface.

The position, number, size, shape, etc. of the ventilation portions 14 may be configured in any way taking into consideration the purpose, sleeping comfort, climate, etc. The method of manufacturing the mattress is not limited to the above. For example, it is possible to remove the covering layer 12 at predetermined positions without forming the protrusions, or to insulate predetermined positions during heat treatment to prevent the covering layer from being formed on the predetermined positions and to use those portions as the ventilation portions 14.

The surface of the covering layer 12 may be uneven. In this case, the ventilation portions 14 may be provided at the bottoms of the recesses, for example, to further promote ventilation. The positions of the ventilation portions 14 are not limited to the pressing surface, but can be provided at other positions, for example, at the bottom or side surface, to ventilate areas that are usually in contact with a bed, wall, floor, etc. and have poor ventilation. The ventilation portions 14 may be formed as incisions without being punched, and ventilation may be promoted from the incisions. Such incisions can be shifted when a load is applied to the surface, creating gaps, thereby further improving ventilation. Such modified examples will be described below.

### Modification 1 of Embodiment 1

FIG. 4 is a schematic diagram of a mattress 1a according to Modification 1 of Embodiment 1. The mattress 1a is produced by fitting a main elastic layer 11a into a mold with an opening at the top surface that is nearly the size of the top surface, placing a heat insulating member over the opening, and then performing heat treatment. The main elastic layer 11a expands and rises from the opening, but since the portion of the main elastic layer 11a in contact with the insulating member does not melt and become a film, so a covering layer 12a is formed other than the portion, and the portion functions as a ventilation portion 14a as it is.

The mattress 1a comprises at least one air vent 152 on the side surface and at least one flow path 151 connecting the air supply and exhaust port 15 and the air vent 152 inside. The air vent 152 can be opened and closed by a plug 153. When the air vent 152 is open, air is preferentially sent to the flow path 151, promoting discharge from the air vent 152, and when the air vent 152 is closed, air is supplied to the entire mattress, increasing the amount of air passing through the ventilation section 14a.

According to such a method, a large ventilation portion can be formed using the heat insulating member. In this example, the ventilation portion 14a is formed only by heat treatment, so that the step of removing the covering layer 12a at predetermined position is eliminated. Moreover, by combining the heat insulating member with a heat conductive member, it is possible to form ventilation portions with a wider variety of shapes. Furthermore, by providing the flow path 151 and the air vent 152, it is possible to preferentially ventilate to desired position. In addition, by opening and closing the air vent 152, it is also possible to adjust the amount of ventilation in each part.

### Modification 2 of Embodiment 1

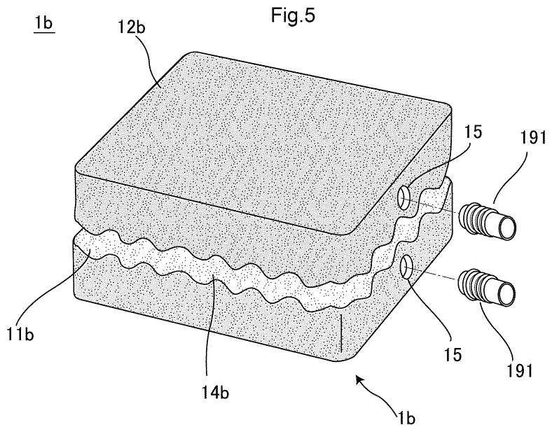

FIG. 5 is a schematic diagram of a mattress 1b according to Modification 2 of Embodiment 1. The mattress 1b is obtained by heat-treating a main elastic layer to form a covering layer 12b over the entire surface, and then dividing it into two parts, upper and lower. Since each cross section (pressing surface) is in a state where a main elastic layer 11b is exposed, the cross section functions as a ventilation portion 14b as it is. At that time, by making the cross section corrugated by profile processing, the pressure applied to the surface during load can be dispersed and high breathability can be ensured. Profile processing is a processing method in which a sponge is compressed alternately from the top and bottom with uneven rollers, and a slicing blade is inserted in the middle to slice the sponge. When released from compression, unevenness is formed on the sliced surface. When such a manufacturing process is adopted, in order to obtain two mattresses from one main elastic layer, it is necessary to heat-treat the main elastic layer having the thickness of two mattresses in advance. In addition, each of the mattresses, which is obtained by the main elastic layer divided into upper and lower parts, is provided with the air supply and exhaust port 15 on the side surface.

According to such a method, the heat treatment for two mattresses and the formation of the ventilation portion for two mattresses can each be performed in one operation. Furthermore, by making the pressing surface corrugated, the pressure caused by the weight of the user is dispersed, so that the airflow of the ventilation portion 14b is not easily obstructed, and a comfortable sleep can be obtained. The means for making the surface corrugated does not necessarily have to be profile processing, and for example, laser cutting processing may be used.

### Embodiment 2

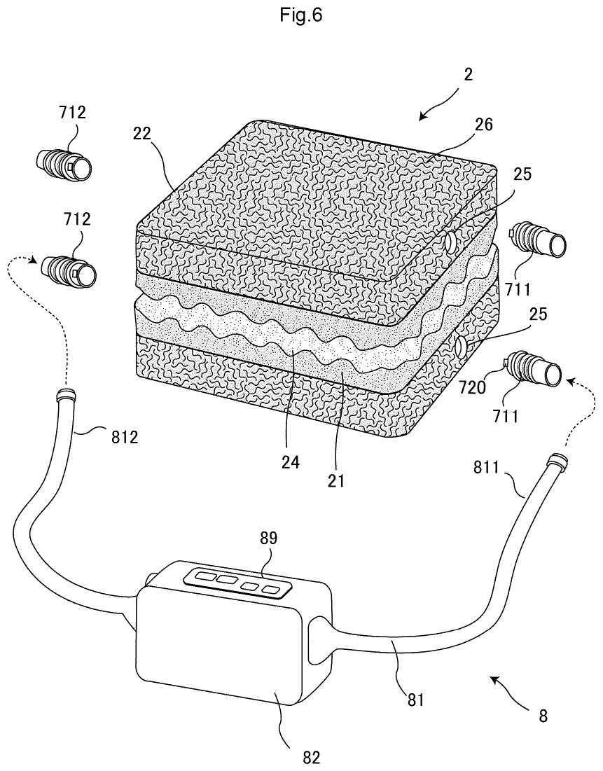

FIG. 6 is a schematic diagram showing an example of a mattress 2 according to Embodiment 2. The mattress 2 is formed by combining elastic layers made of different materials. Specifically, a main elastic layer 21 located on the pressing surface side and having a profiled surface (a ventilation portion 24) and a sub-elastic layer 26 located on the bottom surface side and having air supply and exhaust ports 25 on the side surface are laminated together. The following mainly describes the differences from the above-mentioned embodiment 1, and redundant descriptions will be omitted as appropriate.

The sub-elastic layer 26 is an elastic body made of a material different from that of the main elastic layer 21, or made of the same material but having different characteristics (Newton number or the like). The sub-elastic layer 26 is disposed on the lower side of the main elastic layer 21, and is made of a breathable elastic body having an appropriate thickness and elasticity for supporting the main elastic layer 21. As with the main elastic layer 21, the material may be an elastic body using a synthetic resin having thermoplastic or thermosetting properties, for example, a foam material such as polyethylene foam, a rubber sponge, or a urethane foam, fiber, or the like. The sub-elastic layer 26 and the main elastic layer 21 are laminated internally in the vertical direction so that they can be mutually ventilated. In addition, the sub-elastic layer 26 has higher breathability than the main elastic layer 21.

In a method of manufacturing such a mattress 2, for example, first, a main elastic layer is laminated so as to be sandwiched between two sub-elastic layers 26, and the surface is subjected to heat treatment. Then, the surface of the main elastic layer and the sub-elastic layers 26 are melted to form a film, and a non-breathable covering layer is integrally formed. Thereafter, two main elastic layers 21 are obtained by dividing the main elastic layer into two parts, upper and lower, by profile processing, and the main elastic layer 21 is exposed on the cross section (pressing surface). The corrugated pressing surface of the main elastic layer 21 functions as the ventilation portion 24.

One of the air supply and exhaust ports 25 that connect to a ventilation mechanism 8 is formed in the side surface of the sub-elastic layer 26, and the other air supply and exhaust port 25 is formed in the opposite side surface (not shown in the figure) in this example. A first connection member 711 and a second connection member 811 of the ventilation mechanism 8 are respectively fixed to these air supply and exhaust ports 25 by pins 720, and air supplied from the air supply and exhaust port 25 on the first connection member side is exhausted from the air supply and exhaust port 25 on the second connection member side, thereby achieving higher ventilation. The positions of both air supply and exhaust ports are not particularly limited, but it is preferable to dispose them at symmetrical positions in the mattress so that airflow can be distributed to every corner inside.

The configuration of the ventilation mechanism 8 is not particularly limited as long as it can blow air into the main body of the mattress 2 and can suck air from the main body. Preferably, the ventilation mechanism 8 can reuse the sucked air for blowing air to the main body and circulate the air. The ventilation mechanism 8 may, as an example, include at least one of a cleaning unit, a temperature adjusting unit, and a humidity adjusting unit in addition to an air blowing unit to enable cleaning, heating, humidification, or the like. However, it is also possible to provide two air supply and exhaust ports 25 in the form of mattress 1 as shown in Embodiment 1 above, and connect the ventilation mechanism 8 to each of the air supply and exhaust ports 25.

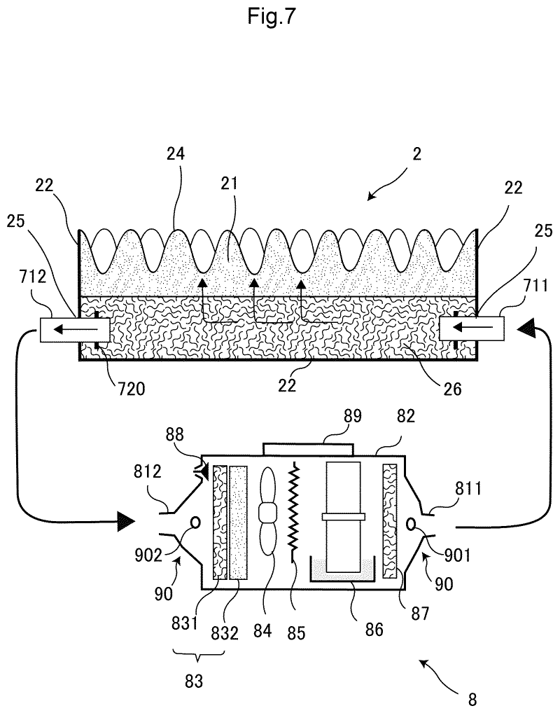

FIG. 7 is a diagram for explaining airflow of the mattress 2 according to Embodiment 2. As shown in FIGS. 6 and 7, the ventilation mechanism 8 of the present embodiment includes a duct unit 81 and a housing 82, and the duct unit 81 includes an air supply duct 811 that detachably connects to the first connection member 711 and an exhaust duct 812 that detachably connects to the second connection member 712. The ventilation mechanism 8 also includes a power supply unit (not shown in the figure). The ventilation mechanism 8 further includes, in the housing 82, a cleaning unit 83, an air blowing unit 84, a temperature adjusting unit 85, a humidity adjusting unit 86, and an adjusting unit 87 in this order from the exhaust duct 812 side (exhaust side). Further, the ventilation mechanism 8 includes an adjustment valve 88 for adjusting the intake of outside air in the housing 82.

The cleaning unit 83 is a component that cleans air and is disposed in the vicinity of the exhaust duct 812. As an example, the cleaning unit 83 includes a first air filter 831 for capturing relatively large particles (such as dust) from the discharged air, and a second air filter 832 for capturing particles finer than those of the first air filter 831. The second air filter 832 is disposed on the air supply duct side (air supply side) of the first air filter 831. Other configurations of the first air filter 831 and the second air filter 832 are not particularly limited as long as they perform the above-mentioned functions.

The air blowing unit 84 includes a fan and a motor for driving the fan, and sucks air in from the exhaust side and blows air out to the air supply side to generate airflow to the air supply side. The start and stop of the operation of the air blowing unit 84 is controlled by a controller 89 described later. The air blowing unit 84 may be configured to be capable of controlling the air volume.

The temperature adjusting unit 85 comprises an electric heating element and can heat the air to be blown, that is, the air blown out from the air blowing unit 84 and passing through. The start and stop of the operation of the temperature adjustment unit 85 is controlled by the controller 89 described later.

The ventilation mechanism 8 may include a heat exchanger as the temperature adjustment unit, and heat or cool the air to be blown by the heat exchanger. The heat exchanger is not particularly limited, and known technologies can be appropriately used. The heat exchanger utilizes, for example, evaporation heat. The heat exchanger uses, for example, a compressor. A part of the temperature adjustment unit may be provided outside the housing 82 and connected externally. For example, it may be externally connected by providing an outdoor unit or connecting to an outdoor unit of an air conditioner. A high temperature (50° C. or higher, preferably 60° C. or higher) ventilation function for killing mites may be provided.

The humidity adjustment unit 86 comprises a humidifying filter and a water reservoir. The humidifying filter is immersed in the water in the water reservoir, and the water permeates the entire humidifying filter by capillary action. The air passing through the humidity adjustment unit 86 is humidified by the moisture supplied by the humidifying filter. The water reservoir comprises a float valve to keep the water level constant. The ventilation mechanism 8 includes a water supply tray (not shown in the figure) that is detachably attached to the housing 82 and can supply water to the water reservoir.

The adjustment unit 87 comprises an adjustment filter and finally adjusts (mixes) the air to be blown.

The controller 89 for controlling the operation of the above components is, for example, provided in the upper portion of the housing 82, comprises an operation unit, and can be operated by the user. The controller 89 comprises, for example, a microcomputer having a processor such as a CPU and a memory such as a RAM or a ROM, and is configured to perform its function by, for example, the processor executing a program stored in the memory.

The ventilation mechanism 8 includes a sensor unit 90 for adjusting the temperature and humidity of supply air to a predetermined value (or predetermined range) according to the user's request (setting). As an example, the sensor unit 90 includes an air supply side sensor unit 901 provided at the root portion of the air supply duct 811 and an air exhaust side sensor unit 902 provided at the root portion of the exhaust duct 812.

The air supply side sensor unit 901: includes a temperature sensor that detects the supply air temperature by detecting the temperature of the root portion of the air supply duct 811 during air supply, and a humidity sensor that detects the supply air humidity by detecting the humidity of the root portion of the air supply duct 811 during air supply. The air exhaust side sensor unit 902 includes a temperature sensor that detects the current (exhaust) temperature of the main body of the connected mattress 2 by detecting the temperature of the root portion of the exhaust duct 812, and a humidity sensor that detects the current (exhaust) humidity of the main body of the mattress 2 by detecting the humidity of the root portion of the exhaust duct 812. Although not shown here, one or more of the above temperature sensor or humidity sensor may be installed in the mattress and connected to the ventilation mechanism 8 for control.

The controller 89 controls the supply air temperature and humidity by turning on and off the above components based on the current temperature and humidity and the set temperature and humidity. For example, when the current temperature is lower than the set temperature and the current humidity is lower than the set humidity, humidified warm air is automatically blown, and when the set temperature and humidity are reached, the blowing of air is stopped. The controller 89 may include a display unit so that the user can check the supply air temperature, humidity, and the like.

When the ventilation mechanism 8 is in operation, an air flow (airflow, wind) is generated as shown by the arrows in FIG. 7. That is, the air in the main body of the mattress 2 is taken into the housing 82 from the exhaust duct 812 by the air blowing unit 84, passes through the cleaning unit 83, and the air blown out by the air blowing unit 84 passes through the temperature adjusting unit 85, the humidity adjusting unit 86, and the adjustment unit 87, where it is adjusted, and then sent out to the main body of the mattress 2 from the air supply duct 811. The air sent into the main body of the mattress 2 from the first connection member 711 enters the sub-elastic layer 26, and is further ventilated upward and passes through the main elastic layer 21 to be discharged from the ventilation portion 24, or is ventilated in the lateral direction and flows back to the ventilation mechanism 8 again from the second connection member 712. The strength of the air current flowing out from each location varies depending on the amount of air supplied from the ventilation mechanism 8, the level of breathability of the main elastic layer 21 and the sub-elastic layer 26 (depending on the material, the amount of voids, the shape, and the like), the position of each air supply and exhaust port 25, and the like, and thus can be designed arbitrarily. In this example, since the sub-elastic layer 26 has higher breathability than the main elastic layer 21, the return flow is facilitated even when the power of the ventilation mechanism 8 is small, and noise can be reduced. Fresh outside air is appropriately inhaled through the control valve 88.

According to such a mattress 2, the corrugated main elastic layer 21 disperses the pressure applied to the pressing surface, and the corrugated recesses are difficult to be completely covered by the human body, so that the breathability of the bottom portions of the recesses are not easily reduced. Thus, high breathability can be ensured even in the contact area between the user and the mattress. This allows the user to more easily receive airflow on their body, allowing them to sleep comfortably.

Furthermore, according to the mattress 2 of the present embodiment, by combining different elastic layers, mattresses with various sleeping comforts can be designed. In addition, the user can optimize the temperature and the humidity to obtain a good night's sleep in a comfortable environment. In addition, the inside of the mattress 2 can be ventilated to every corner to keep it clean.

The temperature of the mattress 2 may be simply adjusted by putting a cooling agent for cooling in summer and a warming agent for warming in winter in the ventilation mechanism 8. A storage portion may be provided inside the mattress to store heat, store moisture or promote drying. The storage portion may be, for example, a space or layer into which a cooling agent or a drying agent can be directly inserted, or the mattress material itself may contain or be coated with a chemical agent having a cooling or drying effect. This allows, for example, the ventilation mechanism 8 to be operated before use to adjust the temperature and humidity inside the mattress, and the ventilation mechanism 8 can be operated to be stopped, intermittently, or at low power during use, thereby providing a low-noise, comfortable sleeping experience. A device capable of heating and cooling may be separately connected to the ventilation mechanism 8. Furthermore, for example, the ventilation mechanism 8 may have a function for adjusting the strength of the airflow, a function for intermittent air blowing (rhythmic airflow), or a timer function. In addition, the inside of the main body can be kept clean by circulating air through an air filter or the like which absorbs or inhales deodorants or insect repellents.

The combination of the sub-elastic layer 26 and the main elastic layer 21 is not limited to the above, and may be laminated or combined in any numbers and any ways as long as mutual breathability is obtained. Different elasticity, breathability, and materials may be combined. In addition, as another material, for example, felt, a resin fiber cushioning material, or the like may be bonded.

In addition, a plurality of mattresses 2 may be ventilated together by connecting them in series or in parallel to the ventilation mechanism 8. Furthermore, the hardness of the elastic layer may be changed depending on the position, or a structure more suitable for ventilation may be added. Furthermore, the formation of the covering layer is not limited to the above, and various methods can be employed to form a coating film integrated with the elastic layer. Such modified examples will be described below.

### Modification 1 of Embodiment 2

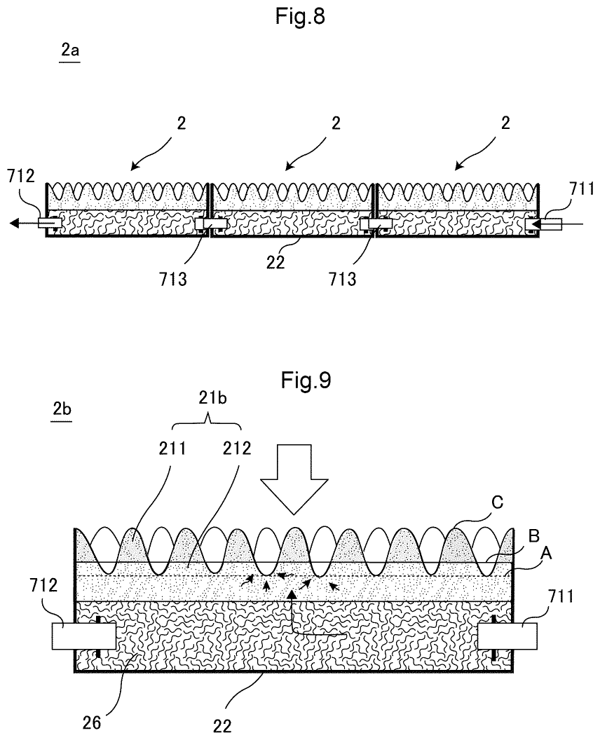

FIG. 8 is a schematic diagram showing an example of a mattress 2a according to Modification 1 of Embodiment 2. The mattress 2a is made up of three mattresses 2 connected side by side in the lateral direction. The mattresses 2 are connected and fixed to each other by connecting parts 713, each connecting part 713 is a hollow tubular member, and the inside thereof becomes an airflow path, allowing the airflow to circulate inside all of the mattresses 2. In this example, the mattress 2a consists of three mattresses 2, but it may consist of any number of mattresses 2.

This allows even large mattresses to be disassembled and handled into individual mattress components, making them easier to manufacture and transport. Furthermore, by making the connecting parts 713, the connection member 711, and the connection member 712 compatible and mutually detachable, it is possible to replace only the damaged or soiled mattress component. Furthermore, when the load is always applied to the same position, it is possible to switch the location and direction of each mattress component as appropriate to prevent deterioration of only certain mattress component.

The connecting method is not limited to the above, and for example, the elastic layers may be connected by the connecting parts or the like without forming the covering layer on the connecting sides of the elastic layers. Furthermore, the elastic layers themselves may be formed into a shape that can be incorporated into each other (e.g., hook-shaped), and then connected and fixed by combining them with each other.

### Modification 2 of Embodiment 2

FIG. 9 is a schematic diagram showing an example of a mattress 2b according to Modification 2 of Embodiment 2. The mattress 2b includes a main elastic layer 21b including a hard portion 211 and a soft portion 212. The hard portion 211 includes at least a part of each of the convex portions of the corrugated pressing surface, and the soft portion 212 includes the rest. The hard portion 211 has a higher hardness (e.g., Newton number) than the soft portion 212.

The hard portion 211 is a part of the upper side of the convex portions, and for example, in the mattress 2b shown in FIG. 9, the height of the hard portion 211 (the height from the apex C of the convex portion to the boundary surface B of the soft portion 212) is about 70% of the total height of the convex portion (the height from the apex C of the convex portion to the base surface A from which the convex portion rises). The height of the hard portion 211 (that is, the position of the boundary surface B) can be freely changed in manufacturing. However, in order to obtain the effect of this example, it is desirable that the height of the hard portion 211 is preferably 30 to 90% of the upper side of the convex portion, and more preferably about 60 to 80%.

The main elastic layer 21b including the hard portion 211 and the soft portion 212 is obtained by laminating different members having different hardness and performing profile processing on the laminated members. The same material may be made to have different hardness by changing the structure or expansion ratio. For example, the expansion ratio of the soft portion 212 is set to be higher than that of the hard portion 211. The upper and lower sides of the same main elastic layer may be integrally formed so that the expansion ratio changes stepwise between the upper side and the lower side of the main elastic layer.

In such a main elastic layer 21b, when the weight of the user is applied, the hard portion 211 sinks while maintaining its shape to some extent. When the soft portion 212 receives this, the vicinity of the base of the convex portion bends unevenly to open the flow path, and the airflow easily flows to the periphery. This ensures a flow path near the weight of the user, especially at the bottom of the concave portion, and allows airflow to be generated efficiently even at the contact area between the user and the mattress.

### Modification 3 of Embodiment 2

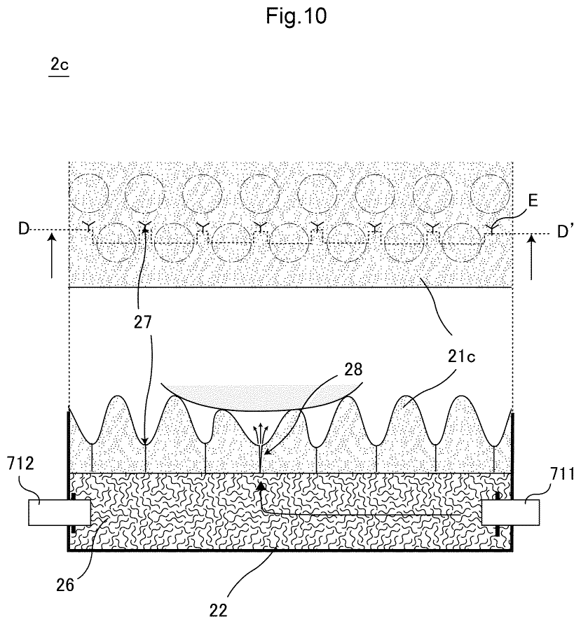

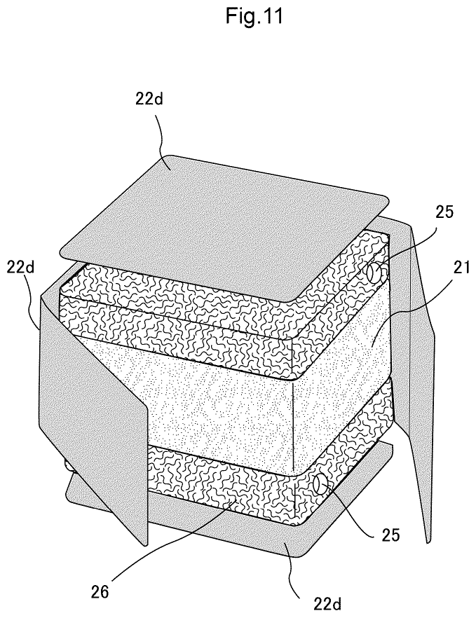

FIG. 10 shows an example of a mattress 2c according to Modification 2 of Embodiment 2, including a top view showing the mattress 2c and a cross-sectional view of the mattress 2c taken along line D-D′ as viewed in the direction of the arrows. The mattress 2c comprises a plurality of ventilation valves 27 penetrating the main elastic layer 21c in the vertical direction at the bottom of the recesses in the corrugated shape of the main elastic layer 21c. Each ventilation valve 27 is, for example, Y-shaped incision, and can be formed by cutting the main elastic layer 21c vertically and evenly at intervals of approximately 120 degrees in three directions from the center E of the bottom portion of the recess. In this example, the cut is Y-shaped, but it may be, for example, a circular or polygonal cylindrical cut.

The ventilation valves 27 can change the amount of ventilation in the vicinity of the pressing surface depending on whether or not a load is applied. Specifically, as shown in the lower view of FIG. 10, the ventilation valves 27 are closed in the non-loaded area, and almost no gap is formed. On the other hand, in the loaded area, at least one ventilation hole 28 opens when the convex portions collapse. This becomes a flow path from the sub-elastic layer 26 to the main elastic layer 21c, so the airflow increases mainly in the vicinity of the loaded area.

In this way, the mattress 2c of this embodiment can ensure a flow path in the loaded area where airflow is easily obstructed, and can adjust the temperature and humidity in the vicinity of the human body. This allows the moisture generated by the human body to be dried efficiently, and the contact area to be heated or cooled intensively.

### Modification 4 of Embodiment 2

FIG. 11 is a schematic diagram showing an example of a mattress 2d according to Modification 4 of Embodiment 2. In the mattress 2d, the surface of a laminated main elastic layer 21 and a sub-elastic layer 26 is covered with a covering material 22d, which is then heat-treated to form a covering layer.

In the method of melting and solidifying the surface of the elastic layer by heat treatment to form a film, when the elastic layer is made of a coarse material with a high expansion ratio, there is a possibility that the elastic layer cannot be uniformly coated or that holes may remain through which the airflow inside the mattress can leak out. Thus, the covering layer can be formed by covering the entire surface with a covering material 22d having thermoplastic or thermosetting properties and heat-treating it. The covering material 22d may be any material suitable for forming a coating film, for example, a synthetic resin sheet having a low expansion ratio and capable of forming a uniform coating film. As a method of covering the elastic layer, for example, winding, packing, or the like can be used.

According to such a method, the quality of the covering layer does not depend on the composition or the material of the elastic layer, so the selection range of the elastic layer is wider. In particular, since the elastic layer does not necessarily have to be thermoplastic or thermosetting, fibers such as coconut shells, wires, and the like, or resins with high melting points, and the like can also be used. In the case of using a material which is not suitable for heat treatment, the elastic layer may be covered with the covering material 22d by bonding or attaching it to the elastic layer without any gaps.

Furthermore, the formation of the covering layer is not limited to the method as described above. For example, a method of coating and covering the surface of the elastic layer with a liquid coating material and then solidifying (drying) the coating material may be employed. For example, the method is such that the surface of the elastic layer is uniformly coated by immersion (dipping), spraying, painting, sputtering, or the like, and then solidified to form the covering layer. The covering layer is made of a flexible material that deforms in accordance with deformation of the elastic layer. The covering layer may be made of the same material as that of the elastic layer. According to such a method, since heat treatment is not required, a large-scale equipment is not required, and a simple manufacturing process can be selected.

Thus, by forming the covering layer integrally with the elastic layer, airflow can be distributed throughout the entire mattress, enabling efficient airflow to be delivered to the user.

Although a person skilled in the art may conceive additional effects and various modifications of the present invention based on the above description, aspects of the present invention are not limited to the examples of the above-described embodiments. Various additions, modifications, and partial deletions can be made without departing from the concept and spirit of the present invention derived from the contents defined in the claims and equivalents thereof.

Reference Signs List

| | |
|---|---|
| 1, 2 | mattress |
| 11, 21 | main elastic layer |
| 12, 22 | covering layer |
| 13 | protrusion |
| 14, 24 | ventilation portion |
| 15, 25 | air supply and exhaust port |
| 19, 8 | ventilation mechanism |
| 26 | sub-elastic layer |
| 81 | duct unit |
| 82 | housing |
| 83 | cleaning unit |
| 84 | air blowing unit |
| 85 | temperature adjusting unit |
| 86 | humidity adjusting unit |
| 87 | adjusting unit |
| 88 | adjustment valve |
| 89 | controller |
| 90 | sensor unit |

1. A mattress, comprising:
a breathable elastic layer;
a non-breathable covering layer covering the elastic layer, the covering layer being a coating film that is integrated with the elastic layer and covers the surface thereof;
a ventilation portion that is not covered by the covering layer; and
a ventilation mechanism,
wherein air supplied to the elastic layer is discharged from the ventilation portion or air supplied to the ventilation portion is discharged from the elastic layer by the ventilation mechanism.

2. The mattress according to claim 1, wherein
the ventilation mechanism sucks the supplied air from a position different from the position where the air is supplied.

3. The mattress according to claim 1, wherein
the covering layer is formed by heat-treating the surface of the elastic layer into the coating film.

4. A method of manufacturing a mattress,
the mattress comprising a breathable elastic layer, a non-breathable covering layer covering the elastic layer, a ventilation portion that is not covered by the covering layer, and a ventilation mechanism, in the mattress air supplied to the elastic layer is discharged from the ventilation portion or air supplied to the ventilation portion is discharged from the elastic layer by the ventilation mechanism,
the method comprising:
(1) heat-treating the surface of the elastic layer into a coating film;
(2) heat-treating a covering material covering the surface of the elastic layer into a coating film; or
(3) applying a liquid covering material to the surface of the elastic layer and solidifying it to form a coating film,
thereby forming the covering layer that is integrated with the elastic layer and covers the surface thereof.

5. The method according to claim 4, further comprising:
forming the ventilation portion by cutting or removing the covering layer.

6. The method according to claim 4,
the elastic layer comprising a main elastic layer and a sub-elastic layer having higher breathability than the main elastic layer and to which the ventilation mechanism is connected,
the method further comprising:
laminating the main elastic layer and the sub-elastic layer and cutting the main elastic layer by profile processing.
